(19) United States
(12) Patent Application Publication
(10) Pub. No.: US 2002/0179848 A1
(43) Pub. Date: Dec. 5, 2002

(54) Apparatus comprising a reagent atomization and delivery system

(76) Inventor: Ilya Feygin, Mountainside, NJ (US)

Correspondence Address: DEMONT & BREYER, LLC, PO BOX 7490, SHREWSBURY, NJ, 07702, US

(21) Appl. No.: 09/872,415

(22) Filed: Jun. 2, 2001

(51) Int. Cl. G01J 1/00

(52) U.S. Cl. 250/458.1; 250/336.1

(57) ABSTRACT

An apparatus comprising a reagent atomization and delivery system. In one embodiment, a reagent atomization and delivery system includes an atomizer that uniformly and simultaneously delivers a spray of atomized reagent toward a plurality of reagent receiving sites on a specimen plate. The reagent atomization and delivery system is advantageously used in conjunction with an imaging system (e.g., visible-spectrum, infrared-spectrum, etc.). Specifically, once the atomized reagent is dispensed, it triggers chemical/physiological reactions that are then advantageously subjected to imaging analysis (e.g., visible-spectrum imaging, infrared spectrum imaging, etc.).

### FIELD OF THE INVENTION

The present invention relates generally to dispensing very small volumes of liquid. More particularly, the invention relates to uniformly and simultaneously dispensing micro-liter volumes of liquid into small discrete regions on a specimen plate for triggering chemical/physiological reactions.

### BACKGROUND OF THE INVENTION

In assay screening, a large number of cellular events (e.g., calcium flux, etc.), physiological and/or molecular events (e.g., chemical reactions, etc.) are monitored and analyzed. These events, hereinafter referred to as “target events,” are usually carried out in parallel in an array of deposits on specimen plates (e.g., slides, multi-well plates, etc.). The deposits comprise one or more reagents, cellular material, etc.

Due to the large number of target events taking place, time-consuming methods that directly examine each deposit, such as by microscopic examination, are unsuitable for data acquisition. Rather, a “snap shot” of the full array on the specimen plate is advantageously taken via visible spectrum or infrared spectrum imaging systems.

Two common visible-spectrum imaging processes are fluorescence imaging and luminescence imaging. In fluorescence imaging, when a target event occurs, a detection reagent in the deposit emits light (i.e., fluoresces) when excited by an appropriate excitation source (e.g., ultraviolet light). The detection reagent is chosen for its ability to interact (e.g., bind, etc.) with a target or to respond to a specific stimulus that is present only if the target event occurs. The emitted light, which provides qualitative and/or quantitative information about the event, is captured and converted to electrical signals using, for example, a charge coupled device (“CCD”). The CCD comprises an array of thousands of sensor cells that are capable of receiving radiation from multiple samples at the same time. The signals are analyzed, via suitable processing electronics/software, to recover information concerning the event. Luminescent imaging (chemi- or bio-) is similar to fluorescence imaging, except that excitation radiation is not required.

FIG. 1 depicts a simplified schematic of a typical imaging device 100 for fluorescence imaging. Imaging device 100 includes cooled CCD camera 102, emission filter 104, optics 106, filter wheel 108 and illumination source 110, interrelated as shown. Some other elements that are part of, or otherwise associated with imaging device 100 but that are not shown in FIG. 1 include a camera control unit, a computer with analysis software, a specimen positioner and a liquid dispenser.

In operation, excitation radiation 112 from illumination source 110 is delivered to specimen plate 114 containing a plurality of deposits. Excitation radiation 112 is delivered, for a pre-determined period of time, toward a selected deposit, group of deposits or the entire plate of deposits. At the end of the time period, the delivery of excitation radiation 112 ceases and a response occurs (i.e., light 116-1, 116-2 is emitted) and is detected. In a process called time resolved fluorescence (“TRF”), after excitation radiation 112 ceases, the response is monitored after a specific delay of a few milliseconds.

Thermal or infrared spectrum imaging is an alternative to visible spectrum imaging. The principle underlying infrared spectrum imaging is that all chemical reactions and physiological processes are accompanied by a change in energy (i.e., heat is absorbed or released), and this energy change can be monitored/measured to obtain useful information about the reactions/processes that are taking place.

FIG. 2 depicts a simplified schematic of an infrared imaging system disclosed in published PCT application WO 99/60630 for monitoring physiological and molecular events. Imaging system 200 comprises an infrared camera 218, including optics 220, that is spaced apart (i.e., the lens has a 6 centimeter focal length) from target 222 (e.g., a specimen plate having deposits—reagents, cellular or non-cellular material—arrayed thereon, etc.). Target 222 is contained within isothermal chamber 224 that reduces temperature variations. The infrared camera monitors radiated heat production from target 222 and images are recorded by central processing unit 226 for data capture and analysis. WO 99/60630 is incorporated by reference herein.

Infrared camera 218 advantageously provides a thermal image of the entire scene. That is, if a micro-well plate with its two-dimensional array of wells is being monitored, a thermal image of each well is obtained substantially simultaneously. This is best accomplished using a focal plane array or “staring” array.

A focal plane array (“FPA”) 328, depicted in FIG. 3, is a monolithic microelectronic device that incorporates thousands of sensing elements 330 that continuously receive IR radiation, capturing an image of the entire scene. FPA-based infrared cameras include a single monolithic FPA detector and optics. Since an FPA-based infrared camera captures an image of all samples simultaneously, it supports ratiometric analysis.

For both visible spectrum and infrared spectrum imaging systems and methods, it is advantageous if not necessary for the reagents, etc., that participate in the reactions being monitored to be delivered substantially simultaneously to locations on the specimen plate. Simultaneous delivery ensures that the reactions occurring at various locations (e.g., each well, etc.) occur at the same time.

Simultaneous delivery is particularly important for time dependent assays (e.g., TRF). Furthermore, simultaneous delivery of reagent is very important for thermal imaging processes that are ratiometric and comparative. Also, to the extent that reagents evaporate, such evaporation is less problematic when reagent is delivered in parallel (simultaneously) rather than sequentially.

Unfortunately, most prior-art liquid delivery systems cannot deliver liquid simultaneously to all wells in a multi-well plate. The art would therefore benefit from a dispenser and system capable of dispensing sub-micro liter volumes of liquid substantially simultaneously to all desired locations on a specimen plate.

### SUMMARY OF THE INVENTION

An apparatus comprising a reagent atomization and delivery system is disclosed. In the illustrative embodiments, the reagent atomization and delivery system is used to uniformly and simultaneously dispense micro-liter volumes of liquid into a plurality of small cavities, for example, such as are defined in a multi-well plate. Once dispensed, the liquid triggers chemical/physiological reactions that are then advantageously subjected to imaging analysis (e.g., visible-spectrum imaging, infrared spectrum imaging, etc.).

In some embodiments in accordance with the principles of the invention, a reagent atomization and delivery system includes an atomizer and a mask. The atomizer delivers a spray of atomized reagent toward a specimen plate. The velocity of liquid droplets that comprise the atomized reagent is advantageously less than about 3 meters per second, and preferably less than about 1 meter per second. The mask, which has a plurality of openings therein, is disposed between the specimen plate and the atomizer. The openings restrict the passage of atomized reagent to the specimen plate, such that liquid is received only at desired regions on the specimen plate. That is, reagent is received within the wells, rather than the region between the wells, on a multi-well plate, for example.

In another embodiment, a voltage or electrical potential is applied to various elements of the reagent atomization and delivery system to electrostatically focus and direct the atomized reagent to desired locations on the specimen plate.

The reagent atomization and delivery system advantageously comprises an ultrasonic atomizer, which consists of an ultrasonic power supply for generating high frequency energy, a converter for converting the high frequency electrical energy to vibrational energy, and an atomizing nozzle for amplifying the vibrations and using them to atomize reagent that is delivered to the nozzle.

### BRIEF DESCRIPTION OF THE DRAWINGS

FIG. 1 depicts a simplified schematic of a typical prior art fluorescence imaging system.

FIG. 2 depicts a simplified schematic of a prior art infrared-spectrum imaging system.

FIG. 3 depicts a focal plane array, such as can be used in the infrared-spectrum imaging system of FIG. 2.

FIG. 4 depicts an apparatus comprising an imaging system and an fluid atomizing and delivery system in accordance with an illustrative embodiment of the present invention.

FIG. 5 depicts an ultrasonic atomizer for use in conjunction with the invention.

FIG. 6 depicts an atomizing nozzle delivering atomizer reagent to a specimen plate in accordance with the principles of the invention.

FIG. 7 depicts a mask sandwiched between an atomizing nozzle and a specimen plate.

FIG. 8 depicts the atomizing nozzle, mask and specimen plate of FIG. 7 arranged to electrostatically focus atomized reagent.

FIG. 9 depicts a visible spectrum imaging system disclosed in U.S. patent application Ser. No. ______ (Atty Dkt. PH1093).

FIG. 10 depicts an infrared spectrum imaging system disclosed in U.S. patent application Ser. No. ______ (Atty Dkt. PH1094).

FIG. 11 depicts a method in accordance with the illustrative embodiment of the present invention.

### DETAILED DESCRIPTION

The terms listed below are given the following specific definitions for the purposes of this specification.

“Atomized liquid” is a liquid that has been broken down into micro-droplets having a diameter less than about 500 microns. For the purposes of this specification, the word “atomized” is synonymous with the word “nebulized.”

“Atomizer” is a device that creates an atomized liquid.

“Infrared Spectrum Radiation” means radiation having a wavelength within a range of about 780 nanometers to about 1 millimeter.

“Reagents” means cellular material, non-cellular material and/or chemicals. Generally, the term “reagent” means anything that is a reactant, solvent or otherwise participates in target events.

“Specimen plate” means a plate on which reagent(s) are disposed. The term “specimen plate” includes multi-well (e.g., micro-titer) plates. Such plates have a plurality of wells (96-well, 384-well, 1536-wells are typical) that are organized in a two dimensional array. The term “specimen plate” also refers to a glass or plastic slide that does not have wells, upon which reagents are deposited in large two-dimensional arrays.

“Target Events” means cellular, physiological and/or molecular events, such as, for example, calcium flux, chemical reactions, etc.

“Visible Spectrum Radiation” means radiation having a wavelength in the visible range, which is about 390 nanometers to about 780 nanometers.

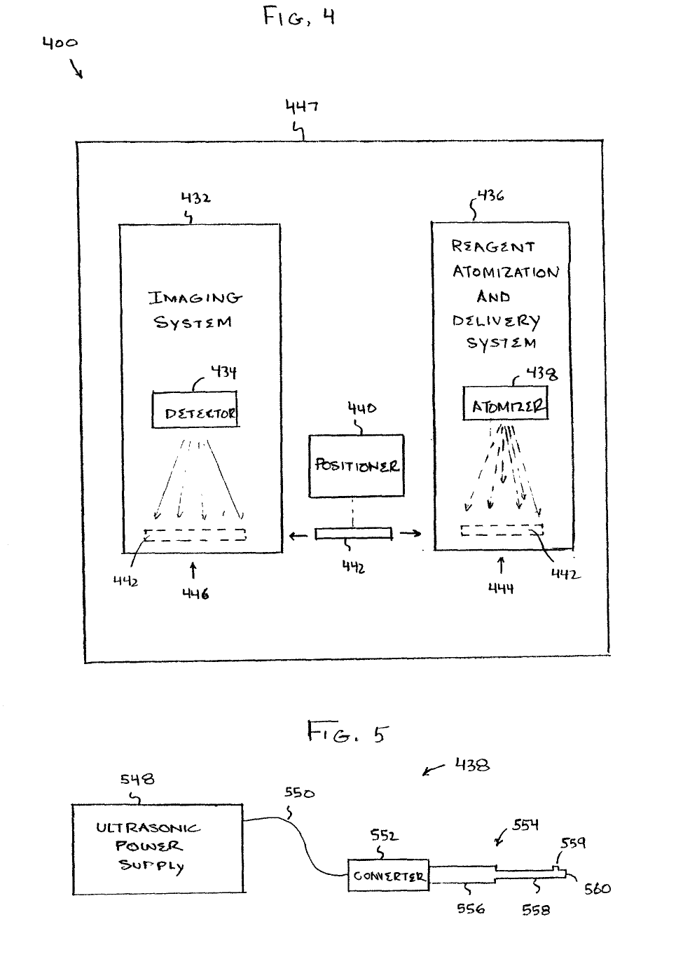

FIG. 4 depicts apparatus 400 in accordance with the illustrative embodiment of the invention. Apparatus 400 comprises imaging system 432, reagent atomization and delivery system 436 and positioner 440. The positioner shuttles specimen plate 442 between first position 444 and second position 446. Positioner 440 can be any one of a variety of mechanisms known in the art for positioning, such as, without limitation, a motorized positioning stage.

In first position 444, specimen plate 442 is operatively engaged to reagent atomization and delivery system 436. That is, specimen plate 442 is positioned to receive reagent in the form of an atomized liquid from atomizer 438. In second position 446, specimen plate 442 is operatively engaged to imaging system 432. That is, specimen plate 442 is positioned such that detector 434 of imaging system 432 can detect target events occurring thereon.

The atomized liquid delivered by atomizer 438 consists of micro-droplets having a diameter of less than about 500 microns. The average size of micro-droplet is advantageously in a range of about 25 to 100 microns. As is well known, a variety of different methods exist for atomizing liquid. And while such methods can suitably be used, atomizer 438 is advantageously an ultrasonic atomizer.

In contrast to most other types of atomizers, ultrasonic atomizers do not rely solely on pressure and high-velocity motion to shear a fluid into micro-droplets. Specifically, ultrasonic atomizers use ultrasonic vibrational energy to enhance atomization. Consequently, the velocity of the micro-droplets generated by ultrasonic atomizers is quite low (i.e., typically less than 0.5 meters/sec) in comparison with the 5 to 20 meters/second velocities typical for pressurized-type atomizers. The low velocity of droplets produced by ultrasonic atomizers advantageously reduces the tendency of the droplets to bounce off a receiving surface, such as specimen plate 442. The velocity of the droplets is advantageously about 3 meters/second or less, and preferably less than about 1 meter per second.

Apparatus 400 is depicted as being contained within environmental enclosure 447. It may not be practical, in all embodiments, to have imaging system 432 within environmental enclosure 447 due to the specific configuration of the imaging system. But in all embodiments, reagent atomizer and delivery system 436 is should be contained with environmental enclosure 447 since the fine, low velocity spray delivered by atomizer 438 is readily disrupted by air currents, etc.

FIG. 5 depicts ultrasonic atomizer 438, which is readily available commercially from Cole-Parmer Instrument Co. (Vernon Hills, Ill.); Lechler GmbH (Germany); Sonics and Materials Inc. (Danbury, Conn.), and others. Ultrasonic atomizer 438 comprises ultrasonic power supply 548, converter 552 and atomizing nozzle 554, interrelated as shown. Ultrasonic power supply 548 converts 50/60 Hz voltage to high frequency electrical energy at 20 kHz or more. This high frequency signal is delivered, over line 550, to converter 552. The converter contains a piezoelectric transducer that changes the high frequency electrical energy to ultrasonic mechanical vibrations. The ultrasonic vibrations are intensified by nozzle 554, which has large diameter portion 556 and small diameter portion 558. Reagent is delivered to nozzle 554 at liquid inlet 559.

Atomizing nozzle 554 operates at a particular frequency that is determined by the frequency generator and optimized by nozzle geometry and the resonant frequency of the thereof. Nozzle 554 must be an integral number of half-wavelengths in length to produce standing waves, which are required to produce atomization. The vibrations are focused at orifice 560 of nozzle 554, which is where atomization takes place. The amplitude of the standing wave is much greater near orifice 560 due to the amplification of motion provided by the step transition in diameter between large diameter portion 556 and small diameter portion 558.

The diameter d<meters> of atomized reagent droplets is related to the surface tension φ <Newtons/meter>, density p<kilogram/cubic meter> and frequency f<Hertz> of the reagent as follows:

d=[φ/(pf²)]^{1/3} [1]

With reference to FIG. 4, specimen plate 442 is positioned, by positioner 440, beneath atomizing nozzle 554 (i.e., in first position 446) to receive reagent in the form of an atomized liquid. As depicted in FIG. 6, atomized reagent 662 is delivered from atomizing nozzle 554 in such a way that the spray just covers specimen plate 442. Coverage is a function of the spray angle and the distance of the nozzle orifice 560 to specimen plate 442. Typically, a spray angle between about 30 to 60 degrees and a distance within the range of about 7.5 to 15 centimeters should provide the requisite coverage for a standard-sized multi-well plate, etc. Using atomizer 438 in accordance with the principles of the invention should result in a coefficient of variation (“cv”) of less than about twelve percent for reagent delivery across specimen plate 442.

It is appreciated that in the embodiment depicted in FIG. 6, atomized reagent 662 completely covers the surface of specimen plate 442. Consequently, for most applications, specimen plate 442 must be a multi-well plate, not a slide or other type of flat plate.

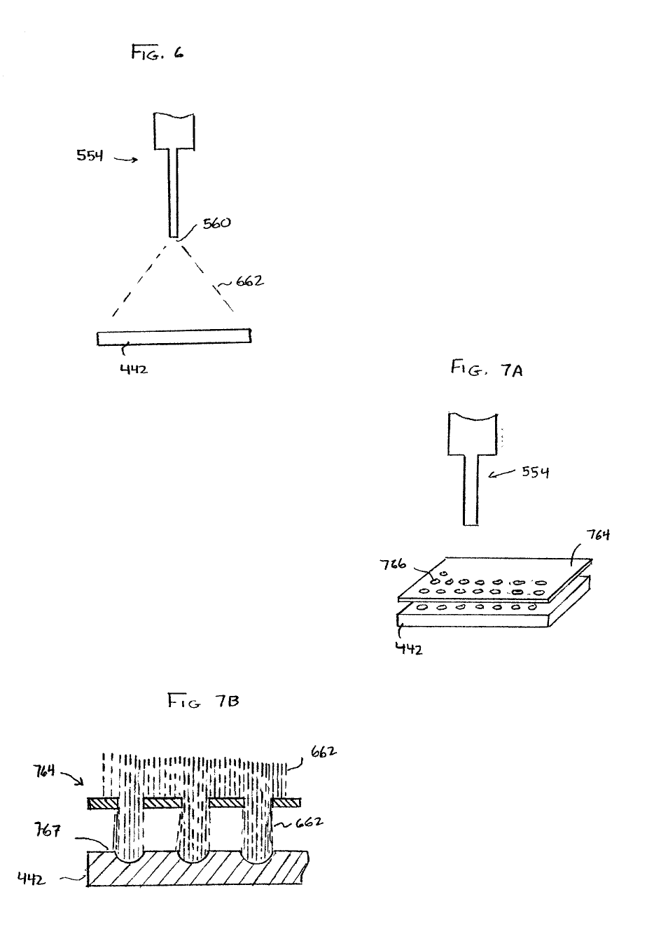

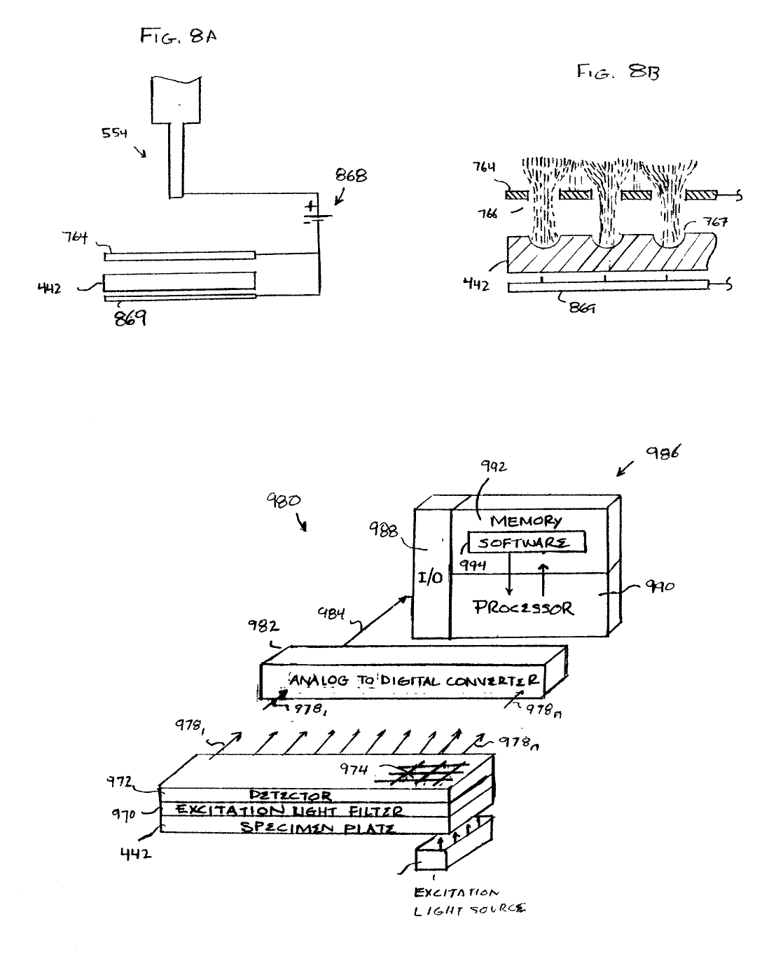

FIG. 7A depicts a variation of reagent atomization and delivery system 436 that addresses the problem of surface contamination of plate 442. In particular, in the variation depicted in FIG. 7, mask 764 is disposed between atomization nozzle 554 and specimen plate 442. Mask 764 defines a plurality of openings 766 that align with the intended deposition sites (e.g. wells, etc.) of reagent on specimen plate 442. As illustrated in FIG. 7B, mask 764 substantially reduces the incidence of over spraying reagent beyond the intended deposition sites 767. Thus, when mask 764 is used, a slide as well as a micro-well plate can be used as specimen plate 442. Mask 764 is wiped (e.g., with teflon blades, etc.) to remove reagent after reagent delivery. Mask 764 can be formed, for example, from stainless steel or any material that does not react with the reagents being used and that is suitably machineable, etc., to create openings 766.

FIGS. 8A and 8B depict a further variant of reagent atomization and delivery system 436 wherein elements of the system are electrically charged to electrostatically focus atomized reagent to the intended deposition sites. As depicted in FIG. 8A, controlled voltage source 868 is electrically connected to atomization nozzle 554 such that the nozzle becomes an anode (positive charge) and is electrically connected to conductive (e.g., metal, etc.) sub-plate 869 that is disposed under specimen plate 442. Sub-plate 869 becomes a cathode (negative charge). Furthermore, controlled voltage source 868 is also electrically connected to mask 764 (which must be suitably conductive to that end) to place a slight positive charge thereon. As depicted in FIG. 8B, mask 764 functions as a grid that directs atomized reagent to the middle of all openings 766. This further reduces the incidence of over spraying the intended reagent deposition sites 767 on specimen plate 442.

To obtain even further improvements in the electrostatically focused delivery of reagent, small electrically-conductive probes or needles (see, FIG. 8B) can be disposed on sub-plate 869 and positionally correlated to the center of each desired reagent delivery site (e.g., the center of each well in a multi-well plate) on specimen plate 442. Since the probes are negatively charged, positively charged atomized reagent is attracted to the probes and, hence, directed toward the center of each reagent delivery site.

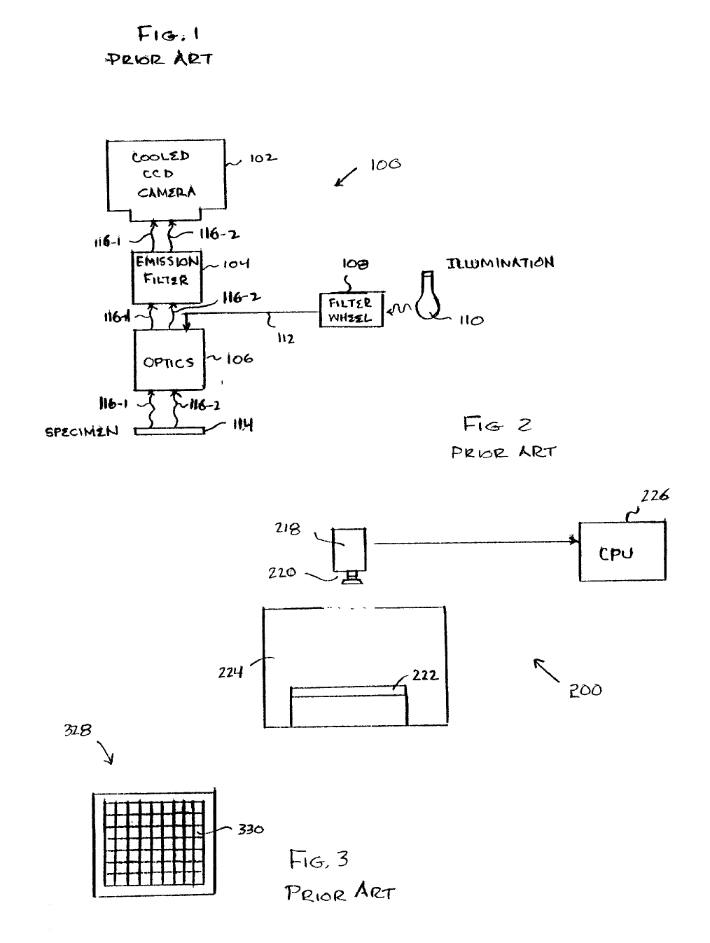

In accordance with the principles of the invention, in some variations of apparatus 400, imaging system 432 is a visible spectrum imager. Suitable visible spectrum imaging systems include, for example, prior art fluorescence or luminescence imaging systems, such as imaging system 100 depicted in FIG. 1.

Further suitable visible spectrum imaging systems include those disclosed in “Method and Apparatus for Visible Spectrum Imaging,” filed on ______ as U.S. patent application Ser. No. ______ (Atty. Dkt. PH1093 filed on even date herewith) and incorporated by reference herein.

In contrast to conventional visible imaging systems, the imaging systems disclosed in U.S. patent application Ser. No. ______ (Atty Dkt. PH1093) have a very small gap between the detector and the reagents on the specimen plate. A methodology for determining gap size is described U.S. patent application No. ______ (Atty Dkt. PH1093). Furthermore, some of the imaging systems disclosed therein do not use optics (e.g., lenses, etc.) between the specimen plate and the detector to collimate or focus emitted light.

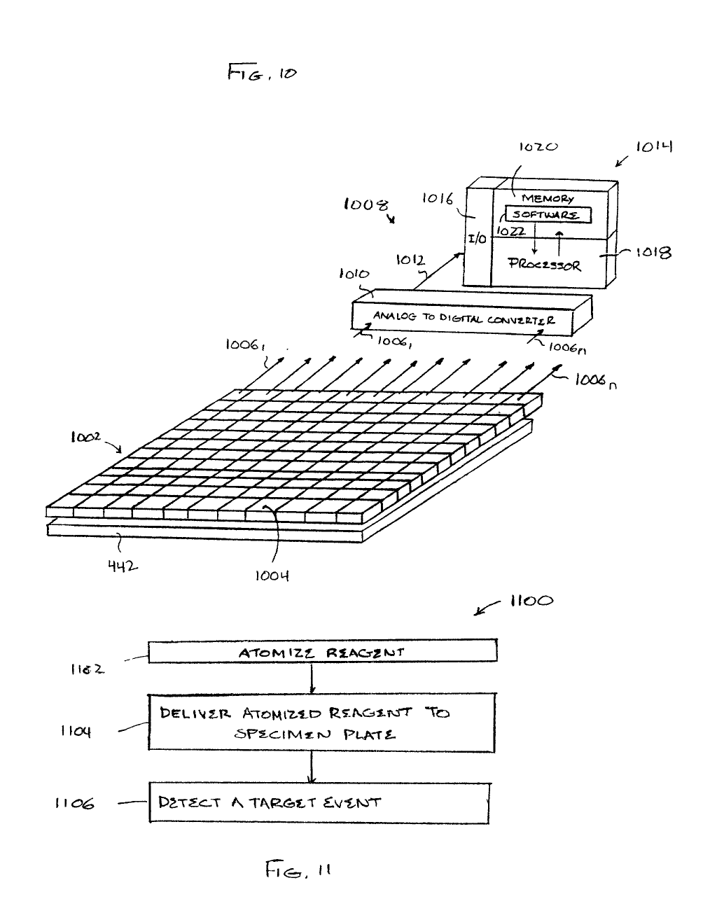

FIG. 9 depicts an illustrative embodiment of the imaging system disclosed in U.S. patent application Ser. No. ______ (Atty Dkt. PH1093). The imaging system comprises specimen plate 442, excitation radiation filter 970, detector 972, excitation radiation source 976 and signal processing electronics 980, arranged as shown. When configured for luminescent imaging, the imaging system does not require excitation radiation source 976 and excitation radiation filter 970.

In the illustrative imaging system depicted in FIG. 9, excitation radiation source 976 is disposed beneath specimen plate 442, which is in turn disposed beneath excitation radiation filter 970, which is in turn disposed beneath detector 972. Many variations on this specific arrangement (i.e., detector 972 above filter 970 above specimen plate 442) are suitable for use in conjunction with the imaging system. Several of these variations are described in U.S. patent application Ser. No. ______ (Atty Dkt. PH1093).

In use, specimen plate 442 has a plurality of reagents disposed thereon, which were delivered thereto by reagent atomization and delivery system 436. Detector 972 detects visible-spectrum light that is generated either directly (i.e., via luminescence) or indirectly (i.e., via fluorescence) from target events that are triggered by the reagent on specimen plate 442. In some embodiments, detector 972 is a CCD camera, well known in the art, that comprises a number of sensor cells 974.

When exposed to electromagnetic radiation having a wavelength that is within its operating range, detector 972 generates electrical signals 978_{i, i=1,n}. Signals 9784_{i, i=1,n} are then delivered to signal processing electronics 980 for analysis. Signal processing electronics 980 include analog-to-digital (“A/D”) converter 982 and data processing system 986. A/D converter 982 converts analog signals 978_{i, i=1,n} to digital signals 984 suitable for processing by data processing system 986.

Data processing system 986 comprises input/output (“I/O”) 988, processor 990, and data storage device 992. I/O 988 includes machine interfaces (e.g., input and output ports, etc.) and human interfaces (e.g., keyboard, monitor, etc.). Data storage device 992 is advantageously a non-volatile memory. Processor 990 is capable of storing data in and retrieving data from data storage device 992, and is further capable of executing programs, such as analysis software 994, that are stored in data storage device 992, and of outputting data to I/O 988. Data processing should be fast enough and powerful enough to simultaneously monitor all wells. This is especially important for time resolved fluorescence (“TRF”) imaging, as is known in the art.

In some additional variations of apparatus 400, imaging system 432 is an infrared spectrum imager. Infrared imaging processes cannot reliably provide quantitative information about target events. This is because changes in emitted infrared radiation due to the occurrence of target events are quite minor in comparison with shifts in ambient temperature due to various mechanisms, including reagent evaporation, etc. Consequently, IR emissions are subject to too much background or “zero” line fluctuation noise for absolute measurements. In other words, the signal- to-noise ratio is too low. But useful ratiometric (i.e., comparative) data can be obtained via infrared spectrum imaging.

Infrared spectrum imaging systems suitable for use in conjunction with invention include prior art infrared imaging systems, such as imaging system 200 depicted in FIG. 2. Further suitable infrared spectrum imaging systems include those disclosed in “Method and Apparatus for Infrared Spectrum Imaging,” filed on as U.S. patent application Ser. No. ______ (Atty. Dkt. PH1094 filed on even date herewith) and incorporated by reference herein.

In contrast to conventional infrared imaging systems, the imaging systems disclosed in U.S. patent application Ser. No. ______ (Atty Dkt. PH1094) have a very small gap between the detector and the reagents on the specimen plate. A methodology for determining gap size is described U.S. patent application Ser. No. ______ (Atty Dkt. PH1094). Furthermore, some of the imaging systems disclosed therein do not use optics (e.g., lenses, etc.) between the specimen plate and the detector to collimate or focus emitted light. FIG. 10 depicts an illustrative embodiment of the imaging system disclosed in U.S. patent application Ser. No. ______ (Atty Dkt. PH1094).

FIG. 10 depicts the infrared-spectrum imaging system disclosed in U.S. patent application Ser. No. ______ (Atty Dkt. PH1094). The imaging system comprises specimen plate 442, detector 1002 and signal processing electronics 1008, arranged as shown. In the illustrative imaging system depicted in FIG. 10, specimen plate 442 is disposed beneath detector 1002. In a variation described in U.S. patent application Ser. No. ______ (Atty Dkt. PH1094) that is suitable for use in apparatus 400 in accordance with the illustrative embodiment of the invention, specimen plate 442 is disposed above detector 1002.

In use, specimen plate 442 has a plurality of reagents disposed thereon, as received by reagent atomization and delivery system 436. Detector 1002 detects infrared-spectrum light that is generated from target events that are triggered by the reagent on specimen plate 442. Infrared-spectrum light detectors incorporate materials that exhibit a response (e.g., generate an electrical signal) to some wavelengths of infrared radiation. To be suitable for use as the chemical component of an infrared detector, an infrared-responsive material must:

exhibit sufficiently high sensitivity (e.g., the ratio of electrical signal output to incident radiation power must be acceptable);

exhibit sufficiently low internal noise (i.e., due to molecular motion);

exhibit a sufficiently linear response;

respond (i.e., how quickly the detector responds to changes in the level of infrared radiation) acceptably fast;

have a sufficient bandwidth.

Illustrative materials that typically satisfy the above requirements, and that are cost effective for use, include (1) lead salts, such as PbS, PbSe and PbTe; (2) indium compounds, such as InSb, InAs and InGaAs; (3) formulations of HgCdTe; and (4) platinum silicide (PtSi). The choice of detector material is a function of application specifics, and those skilled in the art can select a suitable material in light of such specifics.

Detector 1002 is advantageously implemented as a focal plane array, well known in the art. A FPA comprises a regularly organized grouping of thousand of sensor elements 1004. The radiation emitted from a particular region of plate 442 is received by only a small portion of the total of sensor elements 1004 comprising detector 1002. Consequently, multiple groups of sensor elements 1004 are required to detect all of the target events that are occurring on plate 442.

When exposed to infrared-spectrum radiation having a wavelength that is within its operating range, sensor elements 1004 generate an electrical response that is read-out in well known fashion. In this regard, FPAs are similar to the well-known CCDs. FPAs are commercially available from Sensors, Inc. of Princeton, N.J., among others.

The electrical responses from sensor elements 1004 are read-out and combined in known fashion to produce detector output signals 1006_{i, i-1,n}, which are delivered to signal processing electronics 1008 for analysis. Signal processing electronics 1008 include analog-to-digital converter 1010 and data processing system 1014. Analog-to-digital (“A/D”) converter 1010 converts analog signals 1006_{i, i=1,n} to digital signals 1012 suitable for processing by data processing system 1014. Data processing system 1014 is configured in the manner of data processing system 986 described earlier in conjunction with the visible-spectrum imaging system depicted in FIG. 9.

As previously described, reagent atomization and delivery system 436 (FIG. 4) is advantageously contained within an environmental enclosure (e.g., environmental enclosure 447). To the extent that imaging system 432 is contained with environmental enclosure 447 as well, the enclosure should be opaque to the appropriate spectrum of radiation. That is, if imaging system is a visible-spectrum imaging system, enclosure 447 should be opaque to visible light. Similarly, if imaging system 432 is an infrared spectrum imaging system, enclosure 447 should opaque to IR. Since some materials, like polystyrene, are opaque to infrared only in certain wavelength ranges, environmental enclosure 447 advantageously comprises multiple layers of material, as necessary, to provide IR blocking over the appropriate range of wavelengths.

In some embodiments of the present invention, multiple atomizers 438 are present within reagent atomization and delivery system 436, each for dispensing different reagents. For example, while a first atomizer adds the non-varying reagent, the additional atomizers can add, without limitation, accelerating reagents and/or quenching reagents and/or evaporation-reducing reagents, cooling agents, etc.

FIG. 11 depicts a method in accordance with the principles of the present invention. In accordance with operation 1102 of method 1100 (FIG. 11), reagent is atomized. As previously described, atomization is advantageously performed using ultrasonic vibration to form micron-sized droplets of reagent.

In operation 1104, atomized reagent is delivered to a specimen plate. In some embodiments, operation 1102 further comprises the step of positioning said specimen plate in a first position to receive said atomized reagent. In some embodiments, operation 1104 further comprises passing the atomized reagent through a mask, such as mask 766, as previously described (see FIG. 7B). In yet some additional embodiments, operation 1104 further comprises electrostatically focusing the reagent by applying a potential to various elements of reagent atomization and delivery system 436, as previously described.

In accordance with operation 1106, a target event that is triggered by said reagent is detected on said specimen plate. In some embodiments, operation 1106 further comprises the step of positioning said specimen plate in a second position to detect said target event. In some further embodiments, the step of detecting comprises detecting visible spectrum radiation. In some other embodiments, the step of detecting comprises detecting infrared spectrum radiation.

It is to be understood that the above-described embodiments are merely illustrative of the invention and that many variations may be devised by those skilled in the art without departing from the scope of the invention and from the principles disclosed herein. It is therefore intended that such variations be included within the scope of the following claims and their equivalents.

I claim:

1. An apparatus comprising:
a specimen plate having at least a first reagent deposited thereon; and
an atomizer that delivers a spray of a second atomized reagent toward said specimen plate, wherein a velocity of liquid droplets comprising said second atomized reagent is no more than about 3 meters per second.

2. The apparatus of claim 1 further comprising a mask that is disposed between said atomizer and said specimen plate; said mask defining a plurality of openings through which said second atomized reagent passes, the passed reagent being received in discrete regions on said specimen plate.

3. The apparatus of claim 1 further comprising a controlled voltage source that is electrically connected to said atomizer, said mask and a electrically-conductive sub-plate that is disposed beneath said specimen plate, wherein said atomizer is positively charged, said sub-plate is negatively charged, and said mask is positively charged, but said positive charge on said mask is less than the positive charge on said atomizer.

4. The apparatus of claim 1 further comprising a second atomizer that delivers a spray of a third atomized reagent toward said specimen plate, wherein said third atomized reagent is different than said second atomized reagent.

5. The apparatus of claim 1 further comprising an environmental enclosure, wherein said atomizer and said specimen plate are disposed within said environmental enclosure.

6. The apparatus of claim 1 further comprising a positioner that is mechanically engaged to said specimen plate.

7. The apparatus of claim 1, further comprising an imaging system, wherein said imaging system images target events that occur in said liquid droplets on said specimen plate.

8. An imaging system comprising:
a detector for detecting electromagnetic radiation, wherein said electromagnetic radiation is emitted when target events occur, said target events triggered by reagent deposited on a specimen plate; and
an atomizer that delivers said reagent to said specimen plate as a spray of atomized liquid.

9. The imaging system of claim 8 further comprising a positioner; wherein said positioner moves said specimen plate between a first position in which said specimen plate receives said atomized liquid and a second position in which said detector detects said target events.

10. The imaging system of claim 8 further comprising an environmental enclosure, wherein said detector and said atomizer are disposed within said environmental enclosure.

11. The imaging system of claim 8 wherein said detector detects visible spectrum radiation.

12. The imaging system of claim 11 further comprising an excitation radiation source that delivers excitation radiation to said reagent on said specimen plate.

13. The imaging system of claim 8 wherein said detector detects infrared spectrum radiation.

14. The imaging system of claim 8 further comprising a mask that is disposed between said specimen plate and said atomizer; said mask defining a plurality of openings through which said atomized liquid passes and is received by said specimen plate.

15. The imaging system of claim 14 further comprising a controlled voltage source that is electrically connected to said atomizer, said mask and an electrically-conductive sub-plate that is disposed beneath said specimen plate.

16. A method comprising:
atomizing a reagent;
delivering said atomized reagent to a specimen plate; and
detecting a target event triggered by said reagent.

17. The method of claim 16 wherein the step of atomizing comprises using ultrasonic vibration to form micro-droplets of said reagent.

18. The method of claim 16 wherein the step of delivering comprises passing said atomized reagent through a mask.

19. The method of claim 18 wherein the step of delivering further comprises electrostatically focusing said reagent by applying a potential to said mask, said atomized reagent, and an electrically conductive sub-plate that is disposed beneath said specimen plate.

20. The method of claim 16 wherein the step of detecting comprises detecting visible spectrum radiation.

21. The method of claim 16 wherein the step of detecting comprises detecting infrared spectrum radiation.

22. The method of claim 16 further comprising:
positioning said specimen plate in a first position to receive said atomized reagent; and
positioning said specimen plate in a second position to detect said target event.
